(19) United States
(12) Patent Application Publication
(10) Pub. No.: US 2004/0150626 A1
(43) Pub. Date: Aug. 5, 2004

(54) Operator interface panel with control for visibility of desplayed objects

(76) Inventors: Raymond Husman, LeClaire, IA (US); Mark Hockert, Bettendorf, IA (US); Rajesh K. Tiwari, Carol Stream, IL (US)

Correspondence Address: Rajesh K. Tiwari, 363 ST. PAUL BLVD., CAROL STREAM, IL, 60188, US

(21) Appl. No.: 10/354,758

(22) Filed: Jan. 30, 2003

(51) Int. Cl. G09G 5/00

(52) U.S. Cl. 345/173; 345/702

(57) ABSTRACT

The invention implements a means of making objects visible or invisible on HMI display. The object's visibility can be under the user control and/or under the control of connected controller, thereby making the objects context-sensitive. Context-sensitive visibility helps in designing less congested screens thereby making them more operator-friendly. In addition said screens are safer as they eliminate unintentional activation of nearby controls, and eliminate unnecessary and unauthorized activation of controls.

### BACKGROUND

1. Field of Invention

This invention relates to Operator Interface Panels, specifically to means of controlling the visibility of objects displayed on the panels.

2. Discussion of Prior Art

The Operator Interface Panels are also known as Touch Panels, Touch Screens, Man Machine Interfaces (MMI) and Human Machine Interface (HMI). In this document, Operator Interface Panel and HMI are used synonymously. This discussion does not include software-based HMIs that run on a PC or a general-purpose computer system. Rather we cover here the operator interface panels with a dedicated microprocessor.

In many cases Electronic Operator Interface Panels replace much of the hardwired control components from an automation panel, such as Push Button, Indicator Lights, Pilot Lights, Meters, etc. The recent trend in industrial automation shows an increased use of these panels. The reasons for this trend are:

1. Operator Interface Panels save premium panel space.

2. Operator Interface Panels are cost effective alternative to hardwired control components.

3. Automation panels using HMIs can easily be reconfigured as compared to the ones using hardwired controls.

4. Control components can easily be added or deleted from HMI screens as compared to adding/deleting hardwired components from the panel.

5. HMIs offer much more than push buttons and pilot lights. For example, the modern HMIs will allow you to use Bar graphs, Trend Graphs, Alarm capabilities, etc., on screens.

Typically user designs multiple screens or video pages with multiple objects or controls on each page, for use on a HMI. Video pages and screens are used in this document synonymously. Operators navigate through these pages or screens based on their requirements. Screen designers try to place as many objects or controls as possible on each screen to utilize real estate on the operator interface panel display. Typically an operator does not require all the objects placed on one screen to run the machine or process in normal circumstances. Several of the objects are placed on the operational screens to handle exception conditions, such as machine setup and diagnostics. If it were possible to display these objects only when they are needed, the screens will look less congested making them less confusing, while reducing chances of accidental activation of wrong control.

### OBJECTS AND ADVANTAGES

The object and advantage of this invention are as follows:

1. To provide means for controlling visibility of control objects on Operator Interface Panel screens under the control of operator.

2. To provide means for controlling visibility of control objects on Operator Interface Panel screen under the control of connected controller.

3. Making objects visible under certain conditions to make them context sensitive.

4. By using context-sensitive objects, the screens can be made less congested, and more operator friendly.

5. Less congested screens minimizes the chances of activating a wrong control by touching a nearby control unintentionally.

6. Invisible objects eliminate the possibility of unnecessary interaction with the controls.

7. Invisible objects eliminate the possibility of unauthorized interaction with the controls.

### SUMMARY

The invention allows a user to control the visibility of objects on an Operator Interface Panel screen. This makes it possible to display context-sensitive objects on the Panel screens, making the screens less congested. This also makes it possible to restrict access to these objects. In addition, since the screen is less congested, and if the objects are properly placed, the chances of accidental activation of a wrong control are reduced, particularly when operator wears gloves.

### DRAWINGS

FIG. 1 shows a typical system involving an operator interface panel or HMI.

FIG. 2 shows major physical components of an HMI.

FIG. 3 shows an HMI screen with several objects on it.

FIG. 4 shows two screens, both showing a subset of objects from screen shown in FIG. 3.

FIG. 5 shows a portion of a dialog box that relates to the visibility of object

FIG. 6 shows a portion of the firmware in flow chart form that relates to the visibility

### DESCRIPTION OF PREFERRED EMBODIMENT

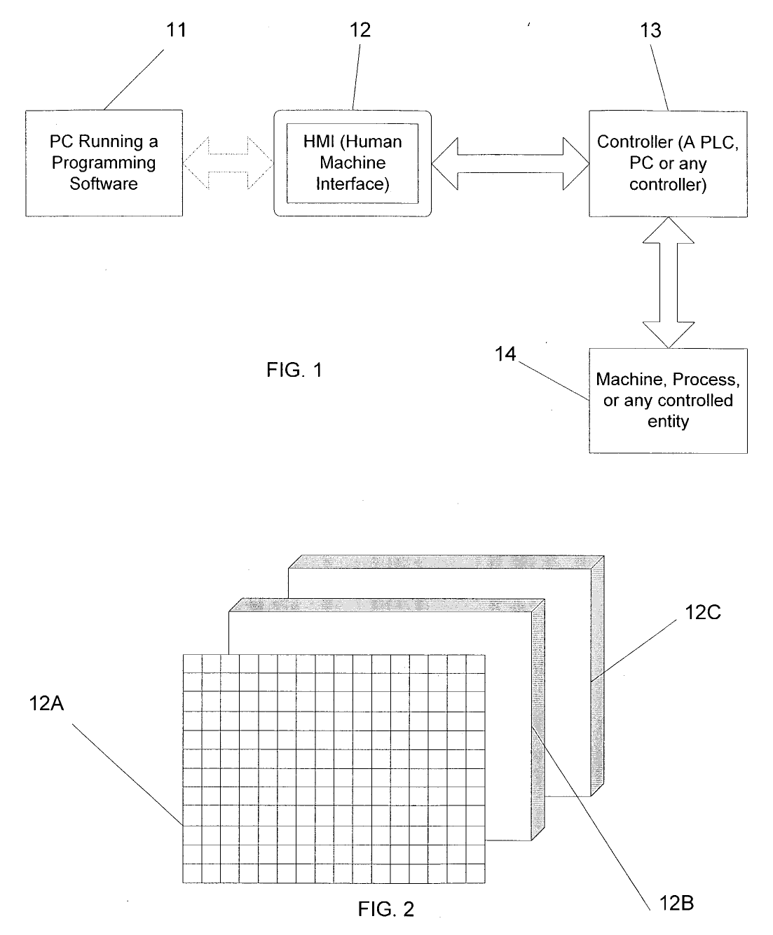

FIG. 1 shows a typical system involving an HMI. The system consists of an HMI 12, a Controller 13, and a controlled entity 14. Typically a PC 11 or a workstation is used only to program the HMI (and hence shown with dashed arrows connected to the HMI).

HMIs are used in various industrial automation control systems, including machine controls, process control, etc. HMIs allow operators to interact with machine, process or any other controlled entity by reading and writing to controller's memory 14. HMI accesses controller memory using addresses for memory locations.

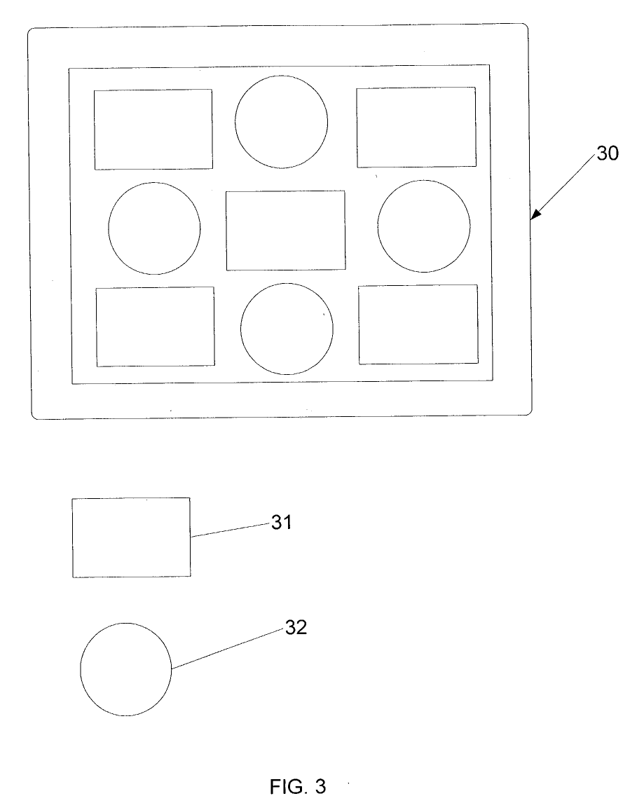

FIG. 2 shows an HMI's construction showing major physical parts of the HMI. HMI 12 typically consist of a flat Liquid Crystal Display (LCD) graphical screen 12B, a touch screen 12A, and associated electronics 12C, and firmware to display graphical shapes, messages, and data information. The FIG. 2 shows the LCD screens for illustration, but the concept is valid even if the display were using any other display technology, such as CRT, EL, or any new maturing technologies. Touch screen is used for operator inputs to the HMI firmware. Although, only touch screen is shown here for means of inputting information by operator, the invention is valid for alternative input means, such as membrane keypad or a combination of touch screen and membrane keypads.

Typically a PC 11 running screen-design software is used to design screens for HMIs. The designed-screens are then transferred to the HMI 12. These screens consists of graphical representations of various control components, such as Push Buttons, Pilot Lights, Indicator Lights, Meters, Message Displays, Numeric Entry Buttons (keypads), Line graphs, Bar graph, etc, collectively called as Objects here.

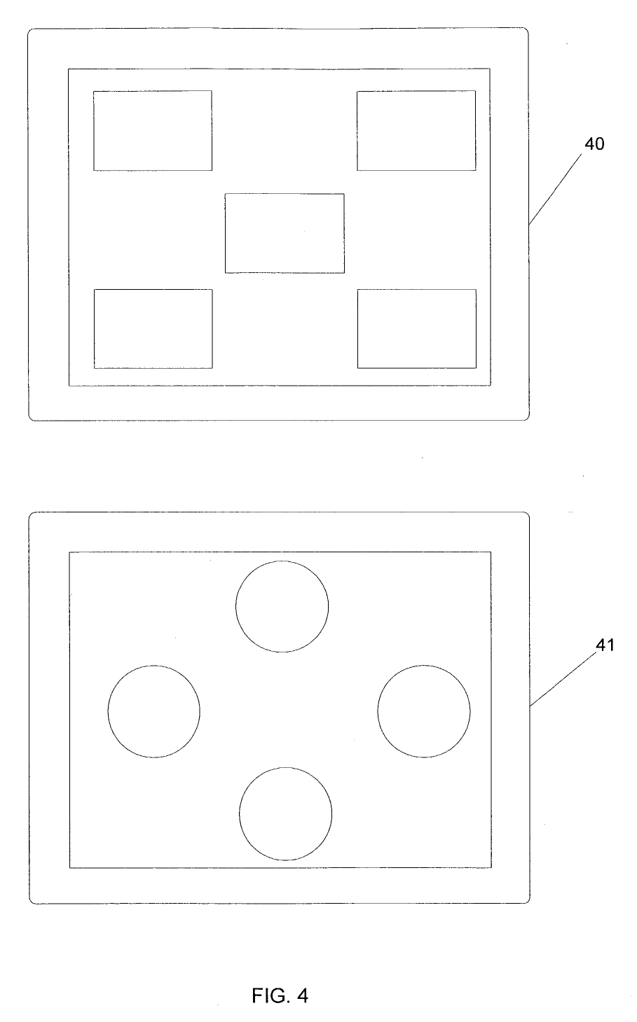

FIG. 3 shows an arbitrary screen 30 showing several objects on it. Only two types of objects 31 32 are shown here for illustration. The objects on screen could be any combination of supported objects. Again, just for illustration, assume that all nine objects (five of type Objects 31, and four of type Object 32) are required for the operation of machine/process. Assume that five objects 31 are required in normal operation condition, and four objects 32 are required when machine has some fault. Obviously, the four objects 32 are not required under normal condition of machine, and can be hidden from the operator under normal operation.

FIG. 4 shows two screens 40 and 41 with only one type of objects displayed in each of the two screens. Screen 40 displays five objects 31, and screen 41 shows four objects 32. Compared to Screen 30, each of the screen 40 and 41 are less congested Objects 31 and 32 are shown for illustration. These could be any mix of the objects supported by the HMI.

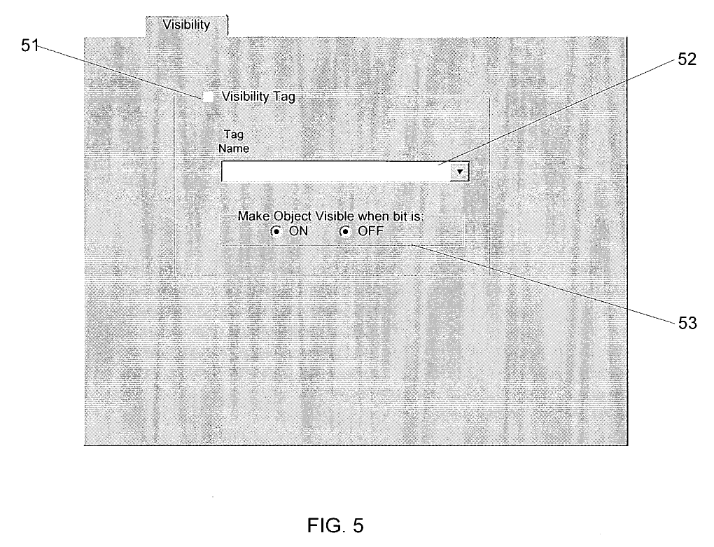

FIG. 5 shows a portion of the dialog box related to visibility of objects.

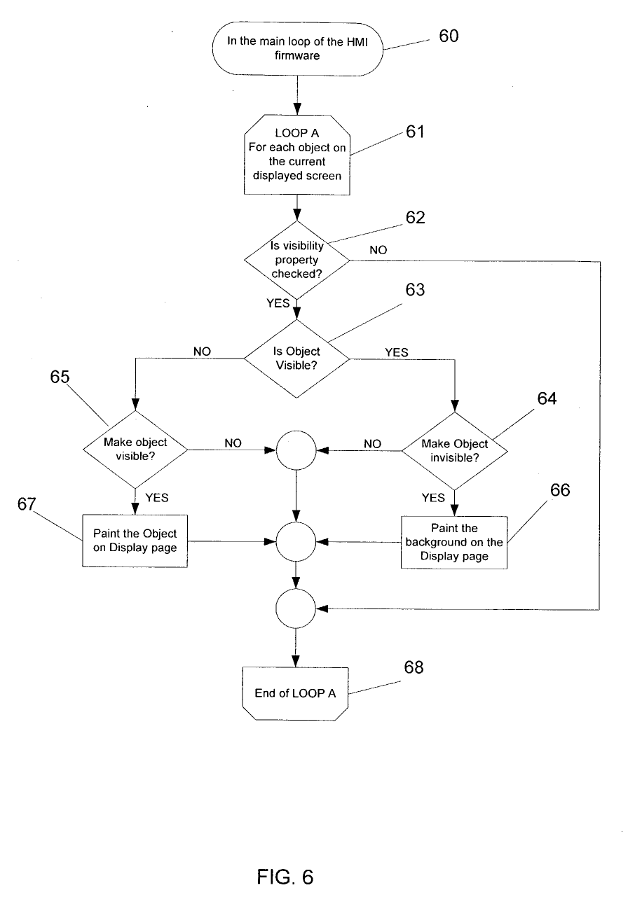

FIG. 6 shows a firmware flow chart related to the visibility of objects.

Included is also a CD that has computer readable screen design software & firmware of an HMI.

Operation

In operation a user would design multiple screens for allowing an operator to interact with controller of the machine/process. The interaction with controller usually means, reading and writing to controller's memory using controller's communication protocol. The screens are designed to mimic real life hardwire control components. For example, screens would have on them Push Button, Indicator Light, Meters, etc.

An object can be placed on a screen purely for cosmetic purposes (such as a bitmap of a company logo), or for display of information (such as displaying a message or a numeric value, say temperature of a chamber), or can have some action associated with them (for example, a push button). A Push Button, when touched, will manipulate (set, reset, toggle, etc) a bit in the controller memory mimicking pressing of a real physical Push Button. The objects, which display some information or react to touch, are associated with the controller memory addresses during screen design.

Screen design is a very subjective thing. What is placed on the screen or how many objects are placed on one screen is very subjective. The invention allows user to hide or make some objects invisible based on controller state or conditions.

In this invention, each visual object that can be placed on a screen of the HMI has a visibility property associated with it (FIG. 5, 51). During screen design, programmer uses dialog box (FIG. 5) to define visibility property of each object (52, 53). Mark the check box Visibility/Tag to enable visibility property for an object. Then provide a discrete variable tag, and the state (on or off) of the variable that would make the object visible. The firmware continuously monitors the controller memory bits (called Tag name 52 in FIG. 5) of all the visibility-enabled objects of currently displayed screen (Flow chart FIG. 6) to determine if the object should be displayed or be made invisible.

The firmware checks for each object (currently visible or invisible) of the current screen to see if user has programmed visibility control for the object (61, 62). If the Visibility property has been programmed, then, firmware checks if the object is currently visible or invisible (63). If the object is visible, then the condition to make it invisible (64) is checked (the State of Tag bit (51) and the programmed condition if it should be made visible when the Tag Bit is ON or OFF (52)). If condition is true, then the object is made invisible by painting the background in the area of the HMI screen occupied by the object (66).

If the object is already invisible, then the condition to make it visible is checked (65). If condition is True, then the object is painted in its area (67). This way under controller's control the object's visibility on the screen is controlled.

Included CD has a screen design software, called PowerPanel Programming software. The software runs on a PC running Windows 98, NT, 2000 or XP operating system with at least 800×600 screen resolution. To install the software follow the instructions given below:

1. The CD is has an auto run feature, i.e. once you insert the CD, it would automatically run the setup program to install the screen design software. Follow on screen instructions to install the software.

2. If for any reason, the CD does not auto run, please explore the CD, Find Setup.exe file and run it. Follow on screen instruction to complete the installation.

To experience the visibility feature that makes the screens context-sensitive, the software has to be used along with one of Uticor's Power Panels. Design a few screens with objects and set the visibility feature for a few of theses objects. Transfer the screens to the PowerPanel. Bring the screen that has objects with the visibility tag set on display. Control the visibility bit of an object to make the object appear & disappear from the screen.

We claim:

1. An operator interface panel, with means to electrically connect to a machine controller, having objects that provide operator input to the machine and/or machine status to the operator, having electrical means to control the visibility of said objects.

2. The operator interface panel of claim 1 wherein the panel has electrical means to program said objects.

3. The operator interface panel of claim 1 wherein the operator input means include means to provide said input by touching said objects.

4. The operator interface panel of claim 3 wherein touching of said objects comprises means to activate electrical switches in the panel.

5. The operator interface panel of claim 1 wherein the operator input means comprise of an overlay made of a thin plastic material mechanically connected to the objects.

6. The operator interface panel of claim 5 wherein the electrical signals have means to convert a specific operator input to input commands to the machine controller.

7. The operator interface panel of claim 5 wherein the overlay generates electrical signals to indicate operator input.

8. The operator interface panel of claim 1 with means to make one or more objects visible or invisible based on operator input.

9. The operator interface panel of claim 1 wherein said objects are displayed on video pages with means to provide said machine status to the operator by changing one or more attributes of said objects, including color, text, or bitmaps of said objects.

10. The operator interface panel of claim 1 with means to make said objects visible or invisible based on said controller's memory contents.

11. An Operator Interface Panel, electrically connected to a machine controller, having visual means of providing operator input to the machine and visual means to provide machine status to the operator, having means to control the visibility of said input and machine status objects.

12. The Operator interface panel of claim 11 wherein said visual means to provide operator input and machine status comprise of a graphical display.

13. The Operator interface panel of claim 12 having electrical and mechanical means to connect a touch screen to the said graphical display.

14. The Operator interface panel of claim 111 wherein said graphical display contains objects that can provide operator input to the machine controller by touching said objects.

15. The Operator interface panel of claim 11 wherein said graphical display comprises of a liquid crystal display or a plasma display or a cathode ray tube.

16. An Electronic Operator Interface Panel with a dedicated microprocessor, electrically connected to a machine controller, having visual means of providing operator input to the machine and visual means to provide machine status to the operator, having means to control the visibility of said input and machine status objects.

17. The Operator interface panel of claim 16 wherein said visual means to provide operator input and machine status comprise of a graphical display.

18. The Operator interface panel of claim 17 having electrical and mechanical means to connect a touch screen to the said graphical display.

19. The Operator interface panel of claim 16 wherein said graphical display contains objects that can provide operator input to the machine controller by touching said objects.

20. The Operator interface panel of claim 16 wherein said graphical display comprises of a liquid crystal display or a plasma display or a cathode ray tube.

21. A method of controlling the visibility of objects in an operator interface panel, comprising:
a. Providing a graphical display for displaying said objects on the screen,
b. Providing means to program conditions for visibility of said objects on said display,
c. Providing means to continuously monitor said conditions,
d. Providing means to make objects visible or invisible based on said conditions.
Whereby said operator interface panel will display only those of said objects that should be visible, and
Whereby the screen appears less congested, and objects appearance on screen become context sensitive.

22. A method of claim 21, comprising:
a. Providing means to connect to a machine controller,
b. Providing means to provide operator input to the machine and/or machine status to the operator,
c. Providing means to change said conditions in method 21 based on operator input and/or machine status,
